(19) United States
(12) Patent Application Publication
(10) Pub. No.: US 2026/0163711 A1
(43) Pub. Date: Jun. 11, 2026

(54) CARRIER AGGREGATION SWITCHING

(71) Applicant: Qualcomm Incorporated, San Diego, CA (US)

(72) Inventors: Kazuki TAKEDA, Minato-ku (JP); Valentin Alexandru GHEORGHIU, Yokohama-shi (JP); Masato KITAZOE, Hachiouji-shi (JP); Timo Ville VINTOLA, San Diego, CA (US); Antti IMMONEN, Helsinki (FI)

(21) Appl. No.: 19/367,164

(22) Filed: Oct. 23, 2025

Related U.S. Application Data
(60) Provisional application No. 63/729,027, filed on Dec. 6, 2024.

(51) Int. Cl. H04L 5/14; H04W 72/232

(52) U.S. Cl. CPC H04L 5/14; H04W 72/232

(57) ABSTRACT

Various aspects of the present disclosure generally relate to wireless communication. In some aspects, a user equipment (UE) may receive a configuration for a carrier aggregation that indicates a frequency division duplexing (FDD) downlink (DL) (FDD-DL) Cell 1, a DL-only Cell 2, and an FDD uplink (UL) (FDD-UL) Cell 1. The UE may perform a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1. Numerous other aspects are described.

### CROSS-REFERENCE TO RELATED APPLICATION

This Patent Application claims priority to U.S. Provisional Patent Application No. 63/729,027, filed on Dec. 6, 2024, entitled “CARRIER AGGREGATION SWITCHING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with carrier aggregation switching.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

Carrier aggregation is a wireless communication technique that involves assigning multiple frequency blocks to a single user in order to increase a data rate. Carrier aggregation may function by combining radio cells. A mobile network operator may combine capabilities of radio cells at different frequency allocations. Carrier aggregation may function by creating a wider channel. Multiple carriers may be used simultaneously to create a wider channel for data spectrum, which may increase the data rate.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example disaggregated network node architecture, in accordance with the present disclosure.

FIG. 3 is a diagram illustrating an example of low-low band carrier aggregation based at least in part on switching, in accordance with the present disclosure.

FIGS. 4-11 are diagrams illustrating examples associated with carrier aggregation switching, in accordance with the present disclosure.

FIG. 12 is a flowchart illustrating an example process performed, for example, by a UE, in accordance with the present disclosure.

FIG. 13 is a flowchart illustrating an example process performed, for example, by a network node, in accordance with the present disclosure.

FIGS. 14-15 are diagrams of example apparatuses for wireless communication, in accordance with the present disclosure.

### SUMMARY

In some implementations, an apparatus for wireless communication at a user equipment (UE) includes one or more memories; and one or more processors, coupled to the one or more memories, configured to cause the UE to: receive a configuration for a carrier aggregation that indicates a frequency division duplexing (FDD) downlink (DL) (FDD-DL) Cell 1, a DL-only Cell 2, and an FDD uplink (UL) (FDD-UL) Cell 1; and perform a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1.

In some implementations, an apparatus for wireless communication at a network node includes one or more memories; and one or more processors, coupled to the one or more memories, configured to cause the network node to: transmit a configuration for a carrier aggregation that indicates an FDD-DL Cell 1, a DL-only Cell 2, and an FDD-UL Cell 1; and perform a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1.

In some implementations, a method of wireless communication performed by a UE includes receiving a configuration for a carrier aggregation that indicates an FDD-DL Cell 1, a DL-only Cell 2, and an FDD-UL Cell 1; and performing a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1.

In some implementations, a method of wireless communication performed by a network node includes transmitting a configuration for a carrier aggregation that indicates an FDD-DL Cell 1, a DL-only Cell 2, and an FDD-UL Cell 1; and performing a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1.

In some implementations, a non-transitory computer-readable medium storing a set of instructions for wireless communication includes one or more instructions that, when executed by one or more processors of a UE, cause the UE to: receive a configuration for a carrier aggregation that indicates an FDD-DL Cell 1, a DL-only Cell 2, and an FDD-UL Cell 1; and perform a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1.

In some implementations, a non-transitory computer-readable medium storing a set of instructions for wireless communication includes one or more instructions that, when executed by one or more processors of a network node, cause the network node to: transmit a configuration for a carrier aggregation that indicates an FDD-DL Cell 1, a DL-only Cell 2, and an FDD-UL Cell 1; and perform a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1.

In some implementations, an apparatus for wireless communication includes means for receiving a configuration for a carrier aggregation that indicates an FDD-DL Cell 1, a DL-only Cell 2, and an FDD-UL Cell 1; and means for performing a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1.

In some implementations, an apparatus for wireless communication includes means for transmitting a configuration for a carrier aggregation that indicates an FDD-DL Cell 1, a DL-only Cell 2, and an FDD-UL Cell 1; and means for performing a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as

hardware or software depends upon the particular application and design constraints imposed on the overall system.

In a multi-carrier scenario, a first serving cell (Cell 1) may be a frequency division duplexing (FDD) cell that has both downlink (DL) and uplink (UL) carriers (e.g., FDD-UL Cell 1 and FDD-DL Cell 1). The FDD cell may be associated with an FDD band. A second serving cell (Cell 2) may be a supplementary downlink (SDL) cell that only has a downlink carrier (e.g., DL-only Cell 2). The SDL cell may be associated with an SDL band. A user equipment (UE) may be associated with both the first serving cell and the second serving cell. The UE may be unable to simultaneously transmit an uplink signal on a Cell 1 uplink carrier (e.g., FDD-UL Cell 1) and receive a downlink signal on a Cell 2 downlink carrier (e.g., DL-only Cell 2) due to a Cell 1 half-duplex implementation. The uplink signal on the Cell 1 uplink carrier (e.g., FDD-UL Cell 1) and the downlink signal on the Cell 2 downlink carrier (e.g., DL-only Cell 2) may be separated by a switching gap time. In other words, between an uplink transmission on FDD-UL Cell 1 and a downlink reception on DL-only Cell 2, the switching gap time may be used. The switching gap time may allow the UE to switch between FDD-UL Cell 1 and DL-only Cell 2. However, the switching gap time may not be properly defined for this scenario. As a result, the UE may be unable to switch between FDD-UL Cell 1 and DL-only Cell 2, which may prevent the UE from performing the downlink reception on DL-only Cell 2, thereby degrading an overall system performance.

Various aspects relate generally to carrier aggregation. Some aspects more specifically relate to carrier aggregation switching. In some examples, a UE may receive, from a network node, a configuration for a carrier aggregation that indicates an FDD-DL Cell 1, a DL-only Cell 2, and an FDD-UL Cell 1. The carrier aggregation may be a low-low band carrier aggregation (e.g., a carrier aggregation involving multiple low bands). The configuration may define a downlink carrier group that includes a first downlink carrier associated with FDD-DL Cell 1 and a second downlink carrier associated with DL-only Cell 2. The configuration may define a paired spectrum that includes the downlink carrier group and an uplink carrier associated with FDD-UL Cell 1. The FDD-DL Cell 1, the DL-only Cell 2, and the FDD-UL Cell 1 may be associated with a virtual cell having a downlink and an uplink on the paired spectrum. The UE may perform, with the network node, a communication via the FDD-DL Cell 1, the DL-only Cell 2, and/or the FDD-UL Cell 1 based at least in part on a switching between the FDD-DL Cell 1, the DL-only Cell 2, and/or the FDD-UL Cell 1. The UE may perform the communication in accordance with an FDD half-duplex operation, which may be supported between the FDD-DL Cell 1, the DL-only Cell 2, and/or the FDD-UL Cell 1. The switching may be between a first carrier group and a second carrier group. The first carrier group may include FDD-DL Cell 1 and FDD-UL Cell 1, and the second carrier group may include FDD-DL Cell 1 and DL-only Cell 2. Alternatively, the first carrier group may include FDD-DL Cell 1 and FDD-UL Cell 1, and the second carrier group may include DL-only Cell 2.

Particular aspects of the subject matter described in this disclosure can be implemented to realize one or more of the following potential advantages. In some examples, by configuring the UE for the carrier aggregation (e.g., low-low band carrier aggregation), the described techniques can be used to perform communications via FDD-DL Cell 1, DL-only Cell 2, and/or FDD-UL Cell 1 based at least in part on the switching between FDD-DL Cell 1, DL-only Cell 2, and/or FDD-UL Cell 1. The UE may be able to switch between carrier groups when performing the FDD half-duplex operation, where the carrier groups may be formed from FDD-DL Cell 1, DL-only Cell 2, and/or FDD-UL Cell 1. The switching may allow the UE to consume a larger number of available resources associated with FDD-DL Cell 1, DL-only Cell 2, and/or FDD-UL Cell 1, which may improve an overall system performance. Otherwise, without the switching, the UE may be unable to utilize some resources associated with FDD-DL Cell 1, DL-only Cell 2, and/or FDD-UL Cell 1.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations,

apparatuses, and techniques described herein may enable one or more of the foregoing technologies or new technologies and/or support one or more of the foregoing use cases or new use cases.

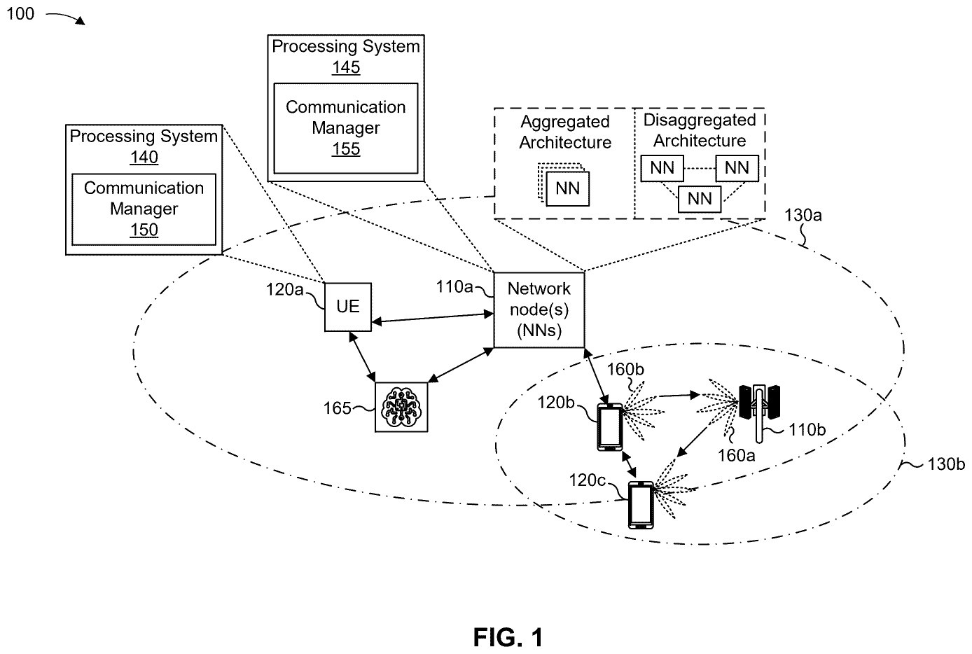

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub- 6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of

multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

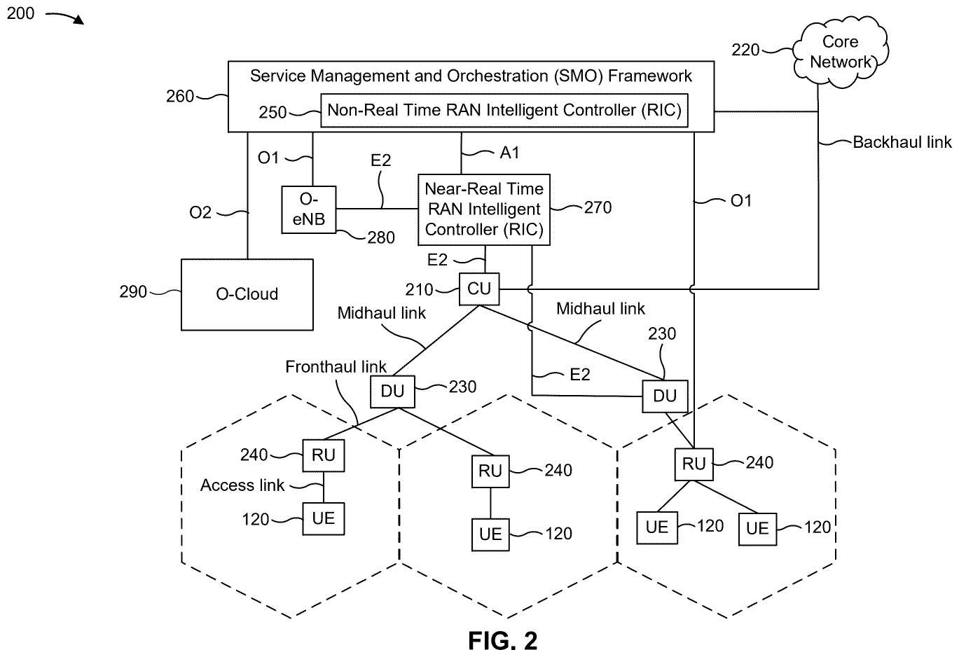

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, a UE (e.g., the UE 120) may include a communication manager 150. As described in more detail elsewhere herein, the communication manager 150 may receive a configuration for a carrier aggregation that indicates an FDD-DL Cell 1, a DL-only Cell 2, and an FDD-UL Cell 1; and perform a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1. Additionally, or alternatively, the communication manager 150 may perform one or more other operations described herein.

In some aspects, a network node (e.g., the network node 110) may include a communication manager 155. As described in more detail elsewhere herein, the communication manager 155 may transmit a configuration for a carrier aggregation that indicates an FDD-DL Cell 1, a DL-only Cell 2, and an FDD-UL Cell 1; and perform a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1. Additionally, or alternatively, the communication manager 155 may perform one or more other operations described herein.

As indicated above, FIG. 1 is provided as an example. Other examples may differ from what is described with regard to FIG. 1.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

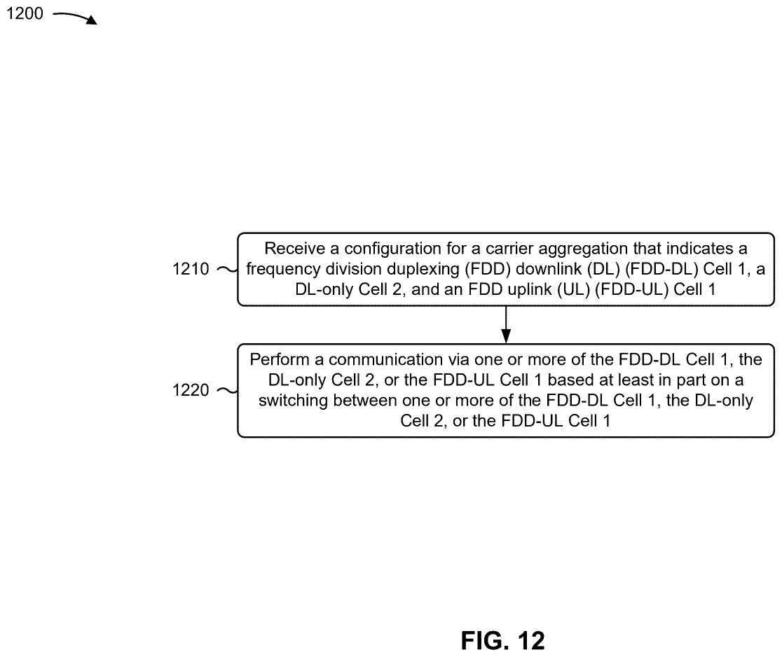

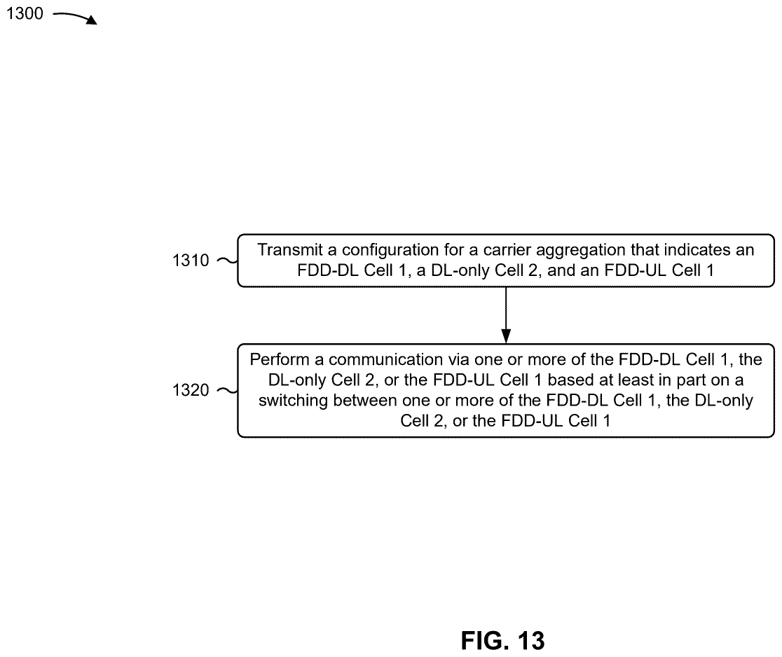

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with carrier aggregation switching, as described in more detail elsewhere herein. For example, the processing system 145 of the network node 110, the processing system 140 of the UE 120, the CU 210, the DU 230, or the RU 240 may perform or direct operations of, for example, process 1200 of FIG. 12, process 1300 of FIG. 13, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1200 of FIG. 12, process 1300 of FIG. 13, or other processes as described herein. In some examples, executing instructions may include running the instructions, converting the instructions, compiling the instructions, and/or interpreting the instructions, among other examples.

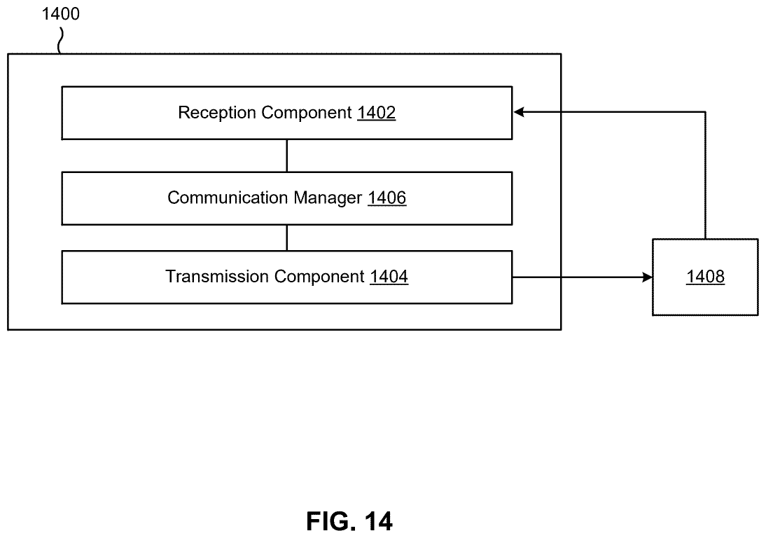

In some aspects, a UE (e.g., the UE 120) includes means for receiving a configuration for a carrier aggregation that indicates an FDD-DL Cell 1, a DL-only Cell 2, and an FDD-UL Cell 1; and/or means for performing a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1. The means for the UE to perform operations described herein may include, for example, one or more of communication manager 150, processing system 140, a radio, one or more RF chains, one or more transceivers, one or more antennas, one or more modems, a reception component (for example, reception component 1402 depicted and described in connection with FIG. 14), and/or a transmission component (for example, transmission component 1404 depicted and described in connection with FIG. 14), among other examples.

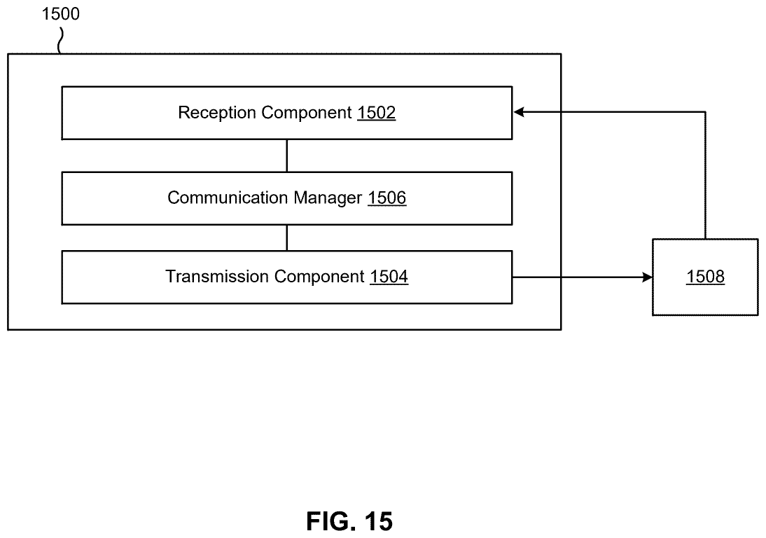

In some aspects, a network node (e.g., the network node 110) includes means for transmitting a configuration for a carrier aggregation that indicates an FDD-DL Cell 1, a DL-only Cell 2, and an FDD-UL Cell 1; and/or means for performing a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1. The means for the network node to perform operations described herein may include, for example, one or more of communication manager 155, processing system 145, a radio, one or more RF chains, one or more transceivers, one or more antennas, one or more modems, a reception component (for example, reception component 1502 depicted and described in connection with FIG. 15), and/or a transmission component (for example, transmission component 1504 depicted and described in connection with FIG. 15), among other examples.

As indicated above, FIG. 2 is provided as an example. Other examples may differ from what is described with regard to FIG. 2.

An amount of mid-band spectrum that an operator holds may be 10 to 20 times greater than an amount of low band spectrum. The mid-band spectrum may be useful closer to sites, whereas the low band spectrum may propagate further distances, which may make the low band spectrum useful further away from sites. The low band spectrum may carry significant traffic volumes in urban (e.g., indoor) areas and rural areas, which may cause low band congestion that degrades a user experience. Low bands may carry significant traffic volumes in mobile network operator (MNO) networks both in urban areas and rural areas. As an example, band 29 is a downlink-only band, and a band 29 capacity may be lost in low-bands-only coverage areas.

Low-low band carrier aggregation (e.g., an aggregation of two or more low bands) may resolve the low band congestion, but low-low band carrier aggregation may not be supported by original equipment manufacturers (OEMs). Low band SDL bands may reach a majority of poor coverage areas, but an absence of a mid-band with an uplink may render the low band SDL bands useless. An SDL utilization may be enabled using low-low band carrier aggregation with minimal impact to UEs.

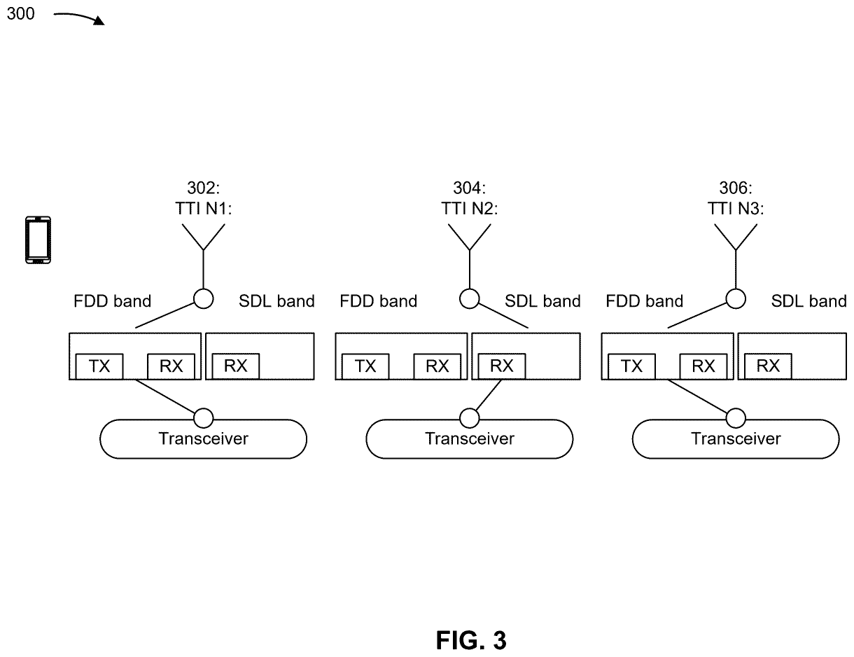

FIG. 3 is a diagram illustrating an example 300 of low-low band carrier aggregation based at least in part on switching, in accordance with the present disclosure.

A UE may support an inter-carrier scheduling. The UE may monitor an FDD downlink PDCCH DCI, which has both an FDD scheduling and an SDL scheduling. The UE may switch back to an FDD duplexer after an SDL scheduled transmission interval is finished.

As shown by reference number 302, at time transmission interval (TTI) N1, a transceiver of a UE may be switched to an FDD band, instead of an SDL band. The FDD band may support both an uplink transmission (Tx) to a network node and a downlink transmission (Rx) from the network node. The FDD band may support simultaneous uplink transmission and downlink reception. The SDL band may support only a downlink transmission (Rx) from the network node. At TTI N1, the UE may be able to transmit or receive via the FDD band. As shown by reference number 304, at TTI N2, the transceiver of the UE may be switched to the SDL band, instead of the FDD band. At TTI N2, the UE may be able to receive via the SDL band. As shown by reference number 306, at TTI N3, the transceiver of the UE may be switched back to the FDD band. At TTI N3, the UE may be able to transmit or receive via the FDD band.

Carrier aggregation, such as low-low band carrier aggregation, that is based at least in part on switching may be applicable to various scenarios, in which a traditional carrier aggregation architecture may not be feasible. For example, a first scenario may involve band 29, which falls within a duplex gap of band 12 and leaves 1 megahertz (MHz) for a filter stopband between a band 12 uplink and a band 29 downlink. A second scenario may involve a band 106 uplink which is separated from a band 26 downlink by 2 MHz. A third scenario may involve a band 67 downlink that overlaps with a band 28 uplink. A fourth scenario may involve aggregating band 5 and band 29 with a single antenna. A fifth scenario may involve aggregating band 14 and band 29. A sixth scenario may involve aggregating band 29 and band 71 via a single antenna.

As indicated above, FIG. 3 is provided as an example. Other examples may differ from what is described with regard to FIG. 3.

In a multi-carrier scenario, a first serving cell (Cell 1) may be an FDD cell that has both downlink and uplink carriers (e.g., FDD-UL Cell 1 and FDD-DL Cell 1). The FDD cell may be associated with an FDD band. A second serving cell (Cell 2) may be an SDL cell that only has a downlink carrier (e.g., DL-only Cell 2). The SDL cell may be associated with an SDL band. A UE may be associated with both the first serving cell and the second serving cell. The UE may be unable to simultaneously transmit an uplink signal on a Cell 1 uplink carrier (e.g., FDD-UL Cell 1) and receive a downlink signal on a Cell 2 downlink carrier (e.g., DL-only Cell 2) due to a Cell 1 half-duplex implementation. The uplink signal on the Cell 1 uplink carrier (e.g., FDD-UL Cell 1) and the downlink signal on the Cell 2 downlink carrier (e.g., DL-only Cell 2) may be separated by a switching gap time. In other words, between an uplink transmission on FDD-UL Cell 1 and a downlink reception on DL-only Cell 2, the switching gap time may be used. The switching gap time may allow the UE to switch between FDD-UL Cell 1 and DL-only Cell 2. However, the switching gap time may not be properly defined for this scenario. As a result, the UE may be unable to switch between FDD-UL Cell 1 and DL-only Cell 2, which may prevent the UE from performing the downlink reception on DL-only Cell 2, thereby degrading an overall system performance.

In various aspects of techniques and apparatuses described herein, a UE may receive, from a network node, a configuration for a carrier aggregation that indicates an FDD-DL Cell 1, a DL-only Cell 2, and an FDD-UL Cell 1. The carrier aggregation may be a low-low band carrier aggregation (e.g., a carrier aggregation involving multiple low bands). The configuration may define a downlink carrier group that includes a first downlink carrier associated with FDD-DL Cell 1 and a second downlink carrier associated with DL-only Cell 2. The configuration may define a paired spectrum that includes the downlink carrier group and an uplink carrier associated with FDD-UL Cell 1. The FDD-DL Cell 1, the DL-only Cell 2, and the FDD-UL Cell 1 may be associated with a virtual cell having a downlink and an uplink on the paired spectrum. The UE may perform, with the network node, a communication via the FDD-DL Cell 1, the DL-only Cell 2, and/or the FDD-UL Cell 1 based at least in part on a switching between the FDD-DL Cell 1, the DL-only Cell 2, and/or the FDD-UL Cell 1. The UE may perform the communication in accordance with an FDD half-duplex operation, which may be supported between the FDD-DL Cell 1, the DL-only Cell 2, and/or the FDD-UL Cell 1. The switching may be between a first carrier group and a second carrier group. The first carrier group may include FDD-DL Cell 1 and FDD-UL Cell 1, and the second carrier group may include FDD-DL Cell 1 and DL-only Cell 2. Alternatively, the first carrier group may include FDD-DL Cell 1 and FDD-UL Cell 1, and the second carrier group may include DL-only Cell 2.

In some aspects, by configuring the UE for the carrier aggregation (e.g., low-low band carrier aggregation), the UE and/or the network node may be able to perform communications via FDD-DL Cell 1, DL-only Cell 2, and/or FDD-UL Cell 1 based at least in part on the switching between FDD-DL Cell 1, DL-only Cell 2, and/or FDD-UL Cell 1. The UE may be able to switch between carrier groups when performing the FDD half-duplex operation, where the carrier groups may be formed from FDD-DL Cell 1, DL-only Cell 2, and/or FDD-UL Cell 1. The switching may allow the UE to consume a larger number of available resources associated with FDD-DL Cell 1, DL-only Cell 2, and/or FDD-UL Cell 1, which may improve an overall system performance. Otherwise, without the switching, the UE may be unable to utilize some resources associated with FDD-DL Cell 1, DL-only Cell 2, and/or FDD-UL Cell 1.

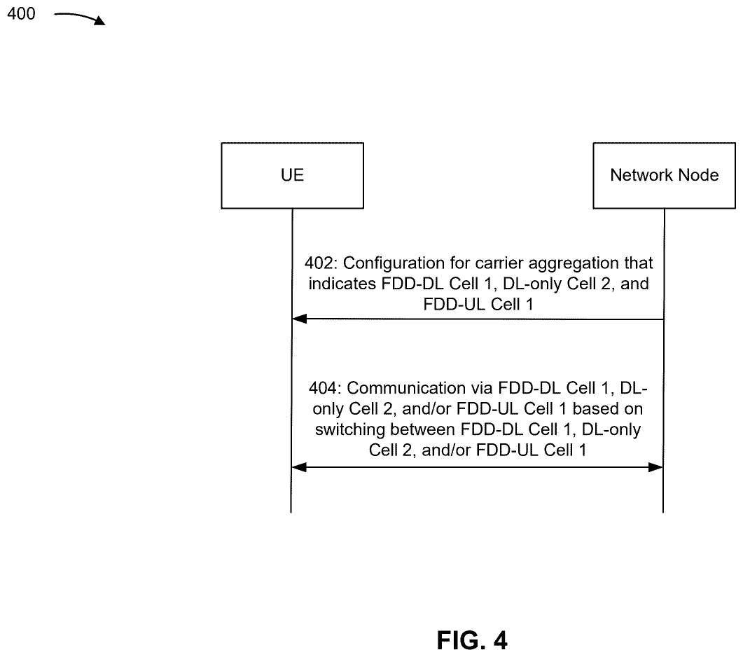

FIG. 4 is a diagram illustrating an example 400 associated with carrier aggregation switching, in accordance with the present disclosure. As shown in FIG. 4, example 400 includes communication between a UE (e.g., UE 120) and a network node (e.g., network node 110). In some aspects, the UE and the network node may be included in a wireless network, such as wireless network 100.

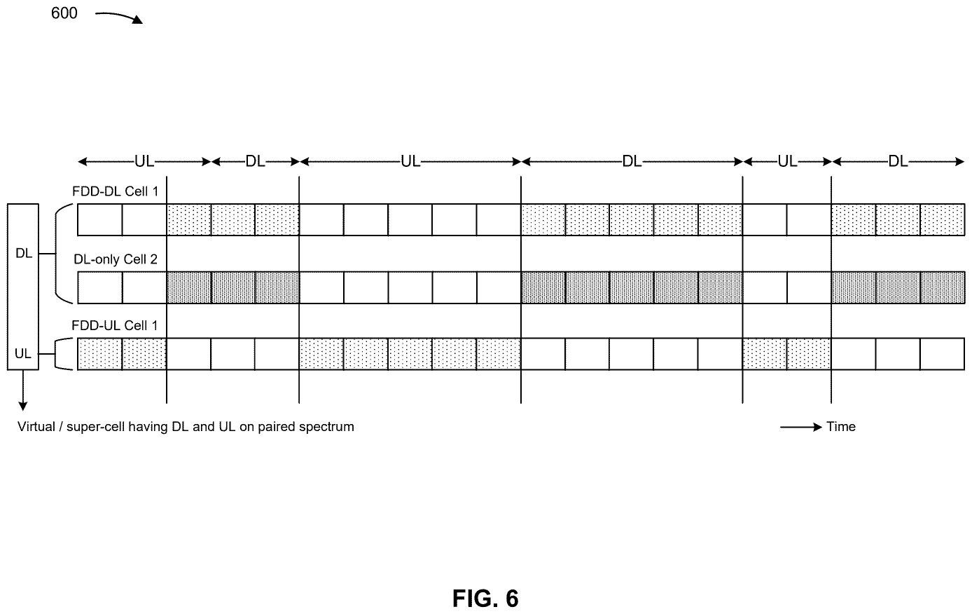

As shown by reference number 402, the UE may receive, from the network node, a configuration for a carrier aggregation that indicates an FDD-DL Cell 1, a DL-only Cell 2, and an FDD-UL Cell 1. The carrier aggregation may be a low-low band NR carrier aggregation (e.g., a carrier aggregation involving multiple low bands). The UE may receive the configuration via RRC signaling or another suitable type of signaling. The configuration may define a downlink carrier group that includes a first downlink carrier associated with FDD-DL Cell 1 and a second downlink carrier associated with DL-only Cell 2. The downlink carrier group may be associated with a virtual downlink carrier that covers both downlink carriers. The configuration may define a paired spectrum that includes the downlink carrier group and an uplink carrier associated with FDD-UL Cell 1. The FDD-DL Cell 1, the DL-only Cell 2, and the FDD-UL Cell 1 may be associated with a virtual cell having a downlink and an uplink on the paired spectrum. The virtual cell, also referred to herein as a virtual/super-cell, is shown in FIG. 6.

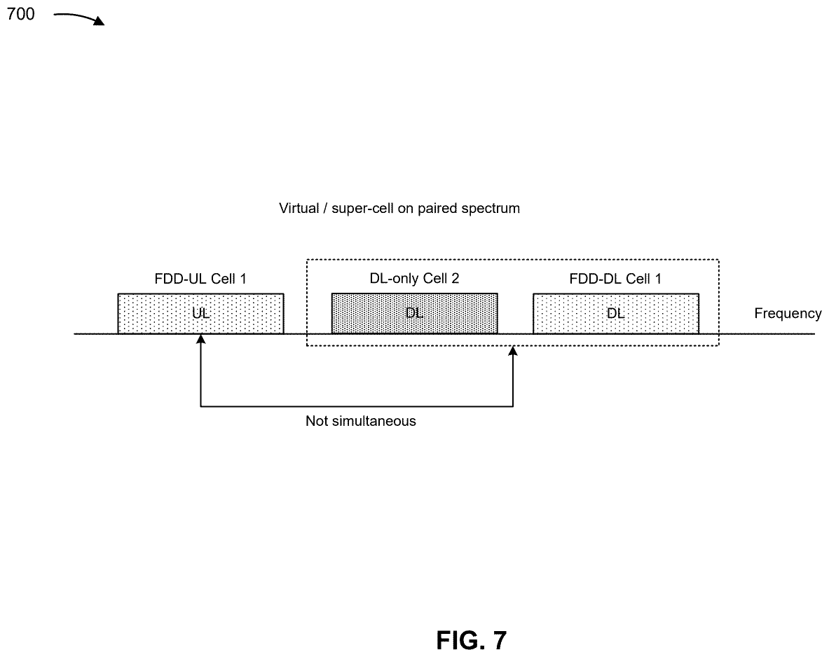

As shown by reference number 404, the UE may perform, with the network node, a communication via the FDD-DL Cell 1, the DL-only Cell 2, and/or the FDD-UL Cell 1 based at least in part on a switching between the FDD-DL Cell 1, the DL-only Cell 2, and/or the FDD-UL Cell 1. The UE and/or the network node may perform the communication in accordance with an FDD half-duplex operation, which may be supported between the FDD-DL Cell 1, the DL-only Cell 2, and/or the FDD-UL Cell 1. The switching between the FDD-DL Cell 1, the DL-only Cell 2, and/or the FDD-UL Cell 1 may be enabled via the configuration. In some aspects, the communication may involve a downlink transmission via DL-only Cell 2, a downlink transmission via FDD-DL Cell 1, and an uplink transmission via FDD-UL Cell 1, as shown in FIG. 7. The downlink transmission via DL-only Cell 2 and the downlink transmission via FDD-DL Cell 1 may be simultaneous downlink transmissions, and the simultaneous downlink

transmissions may not be simultaneous with the uplink transmission via FDD-UL Cell 1.

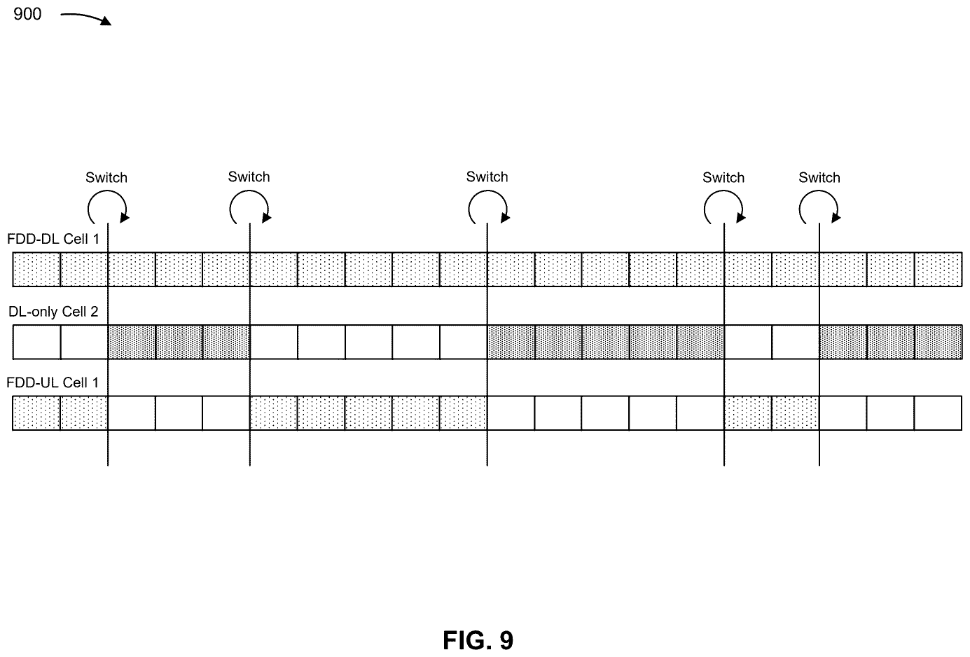

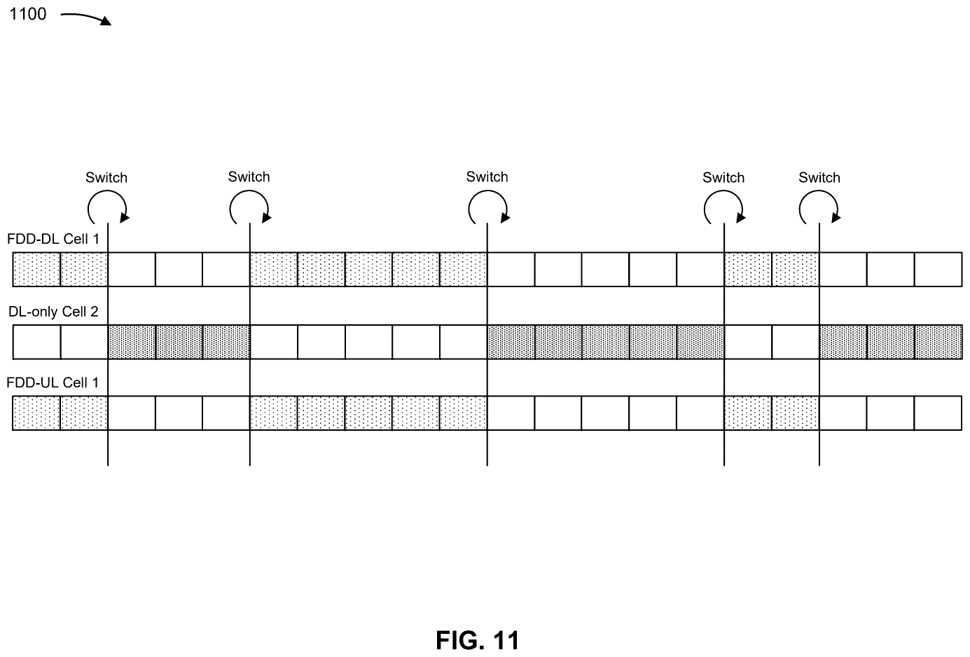

In some aspects, the switching may be between a first carrier group and a second carrier group. The first carrier group may include FDD-DL Cell 1 and FDD-UL Cell 1, and the second carrier group may include FDD-DL Cell 1 and DL-only Cell 2, which is shown in FIG. 9. Alternatively, the first carrier group may include FDD-DL Cell 1 and FDD-UL Cell 1, and the second carrier group may include DL-only Cell 2, which is shown in FIG. 11. The switching between the first carrier group and the second carrier group may allow a maximum number of allocated resources to be used for the communication. For example, all resources associated with FDD-DL Cell 1 may be utilized for the communication. The switching between the first carrier group and the second carrier group may enable the communication even when the UE supports a filter bandwidth for either DL Cell 1 or DL Cell 2.

In some aspects, the switching may be based at least in part on a signaling, a timer, and/or a rule. The signaling may include RRC signaling, a MAC-CE, or DCI. The timer may include a MAC timer or a PHY timer. The rule may be based at least in part on a scheduled transmission, a configured transmission, a scheduled reception, or a configured reception.

As indicated above, FIG. 4 is provided as an example. Other examples may differ from what is described with regard to FIG. 4.

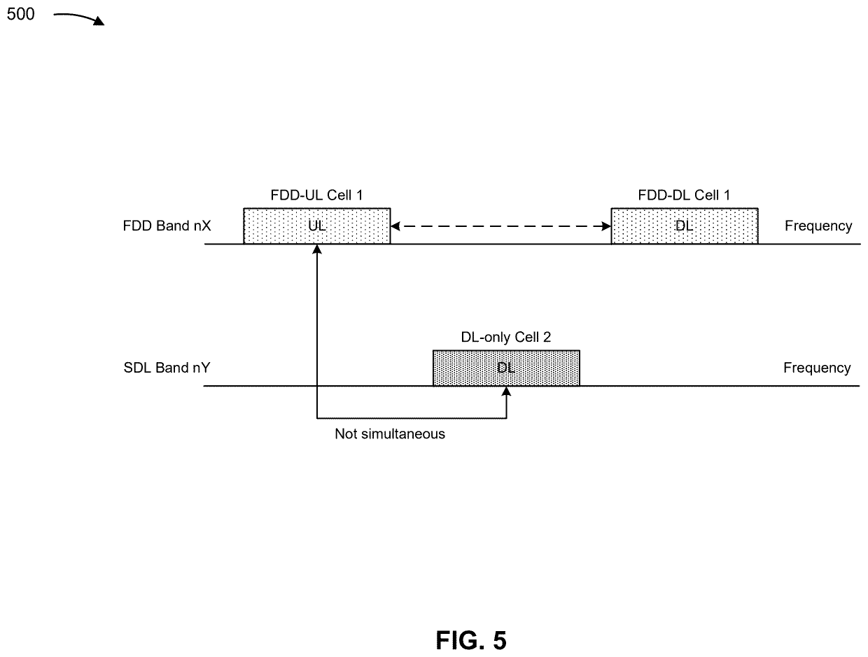

FIG. 5 is a diagram illustrating an example 500 associated with carrier aggregation switching, in accordance with the present disclosure.

As shown in FIG. 5, in a multi-carrier scenario, a serving cell (Cell 1) may be an FDD cell that has both downlink and uplink carriers (e.g., FDD-UL Cell 1 and FDD-DL Cell 1). The FDD cell may be associated with FDD band nX. A serving cell (Cell 2) may be an SDL cell that only has a downlink carrier (e.g., DL-only Cell 2). The SDL cell may be associated with SDL band nY. A UE may be unable to simultaneously transmit an uplink signal on a Cell 1 uplink carrier (e.g., FDD-UL Cell 1) and receive a downlink signal on a Cell 2 downlink carrier (e.g., DL-only Cell 2) due to a Cell 1 duplex implementation. The uplink signal on the Cell 1 uplink carrier (e.g., FDD-UL Cell 1) and a downlink signal on the Cell 1 downlink carrier (e.g., FDD-DL Cell 1) may be separated by a duplex gap. The uplink signal on the Cell 1 uplink carrier (e.g., FDD-UL Cell 1) and the downlink signal on the Cell 2 downlink carrier (e.g., DL-only Cell 2) may be separated by a switching gap time. In other words, between an uplink transmission on FDD-UL Cell 1 and a downlink reception on DL-only Cell 2, the switching gap time may be used. The switching gap time may not be properly defined for this scenario. Further, the UE may not be configured with a mechanism to indicate its incapability of simultaneous transmit-receive operations on FDD band nX and SDL band nY.

As indicated above, FIG. 5 is provided as an example. Other examples may differ from what is described with regard to FIG. 5.

FIG. 6 is a diagram illustrating an example 600 associated with carrier aggregation switching, in accordance with the present disclosure.

In some aspects, a virtual downlink carrier may be defined that includes two downlink carriers. The two downlink carriers may include a first downlink carrier for FDD-DL Cell 1 and a second downlink carrier for DL-only Cell 2. A half-duplex approach for a paired spectrum may be reused for a virtual paired spectrum. The virtual downlink carrier may be defined to cover both downlink carriers of Cell 1 and Cell 2, and a corresponding virtual paired spectrum may be defined. The corresponding virtual paired spectrum may include both the virtual downlink carrier (FDD-DL Cell 1 and DL-only Cell 2) and an uplink carrier (FDD-UL Cell 1). Between a downlink and an uplink of a virtual/super-cell, an FDD half-duplex operation may be enabled.

As shown in FIG. 6, a UE may receive simultaneous (or near-simultaneous) downlink transmissions via FDD-DL Cell 1 and DL-only Cell 2, which may be based at least in part on a carrier aggregation. FDD-DL Cell 1 and DL-only Cell 2 may be associated with a virtual downlink carrier that covers both downlink carriers of Cell 1 and Cell 2. The UE may transmit an uplink transmission via FDD-UL Cell 1. The downlink transmissions and the uplink transmission may be in accordance with a half-duplex operation. FDD-DL Cell 1, DL-only Cell 2, and FDD-UL Cell 1 may be associated with a virtual/super-cell having both a downlink and an uplink on a paired spectrum. The virtual/super-cell may be associated with a corresponding virtual paired spectrum.

As indicated above, FIG. 6 is provided as an example. Other examples may differ from what is described with regard to FIG. 6.

FIG. 7 is a diagram illustrating an example 700 associated with carrier aggregation switching, in accordance with the present disclosure.

As shown in FIG. 7, in a multi-carrier scenario, a serving cell (Cell 1) may be an FDD cell that has both downlink and uplink carriers (e.g., FDD-UL Cell 1 and FDD-DL DL Cell 1). The FDD cell may be associated with FDD band nX. A serving cell (Cell 2) may be an SDL cell that only has a downlink carrier (e.g., DL-only Cell 2). The SDL cell may be associated with SDL band nY. A UE may simultaneously (or near simultaneously) transmit downlink transmissions via FDD-DL Cell 1 and DL-only Cell 2, which may be based at least in part on a carrier aggregation. The downlink transmissions may be associated with separate frequencies. The UE may transmit an uplink transmission via FDD-UL Cell 1. The downlink transmissions and the uplink transmission may be in accordance with a half-duplex operation. In other words, the downlink transmissions and the uplink transmission may not be transmitted in a simultaneous manner in accordance with the half-duplex operation.

As indicated above, FIG. 7 is provided as an example. Other examples may differ from what is described with regard to FIG. 7.

In some aspects, a UE may indicate, to a network node, its incapability of a simultaneous Tx-Rx operation between an uplink carrier of a cell and a downlink carrier of another cell via a UE capability signaling. The UE capability signaling may be a newly defined signaling, or the UE capability signaling may be based at least in part on an enhancement to an existing signaling, such as a simultaneous Rx-Tx inter-band carrier aggregation (simultaneousRxTxInterBandCA) signaling. The simultaneous Rx-Tx inter-band carrier aggregation signaling may have previously been for only time division duplexing (TDD)-TDD and TDD-FDD inter-band NR carrier aggregation.

In some aspects, the network node may configure the UE with a half-duplex operation for a virtual paired spectrum. The virtual paired spectrum may include a virtual downlink carrier (FDD-DL Cell 1 and DL-only Cell 2) and an uplink carrier (FDD-UL Cell 1).

In some aspects, a collision handling between a downlink transmission and an uplink transmission of the virtual paired spectrum may follow a first option, a second option, or a third option. The first option may be associated with all error cases. The network node may ensure that no collision is present between the downlink transmission and the uplink transmission. The second option may be associated with a half-duplex (HD)-FDD for a RedCap UE. The third option may be associated with an HD inter-band TDD-TDD carrier aggregation for a non-RedCap UE. A directional collision handling parameter may be set to “enabled” for a set of one or more serving cells among multiple serving cells.

In some aspects, a time gap between a switch to/from the downlink transmission and the uplink transmission of the virtual paired spectrum may follow a transition time. A Tx-to-Rx transition time (N_{Tx-Rx}) may be 25,600 for FR1 and 13,792 for FR2. An Rx-to-Tx transition time (N_{Rx-Tx}) may be 25,600 for FR1 and 13,792 for FR2. In these examples, 25,600 and 13,792 refer to 25600×Tc and 13792×Tc, where Tc=1/(480k×4096) seconds, and where 25,600 corresponds to roughly 13 microseconds and 13,792 corresponds to roughly 7 microseconds. Other values for the Tx-to-Rx transition time and the Rx-to-Tx transition time may also be possible (e.g., a transition time may be one OFDM symbol or one slot duration). The other values may be applicable to different switching options.

In some aspects, for the collision handling between the downlink transmission and the uplink transmission of the virtual paired strum, and for the first option that considers the error cases, a UE not capable of full duplex communication and not supporting simultaneous transmission and reception, as defined by one or more parameters, among all cells within a group of cells may not be expected to transmit in an uplink in one cell within the group of cells earlier than N_{Rx-Tx}T_{c} after an end of a last received downlink symbol in the same or different cell within the group of cells. In some aspects, a UE not capable of full duplex communication and not supporting simultaneous transmission and reception, as defined by one or more parameters, among all cells within a group of cells may not be expected to receive in a downlink in one cell within the group of cells earlier than N_{Tx-Rx}T_{c} after an end of a last transmitted uplink symbol in the same or different cell within the group of cells. In some aspects, a UE not capable of full duplex communication may not be expected to transmit in an uplink earlier than N_{Rx-Tx}T_{c} after an end of a last received downlink symbol in the same cell. In some aspects, a UE not capable of full duplex communication may not be expected to receive in a downlink earlier than N_{Tx-Rx}T_{c} after an end of a last transmitted uplink symbol in the same cell.

In some aspects, for the collision handling between the downlink transmission and the uplink transmission of the virtual paired strum, and for the second option that involves the HD-FDD for the RedCap UE, downlink/uplink collision handling rules of Type-A HD FDD may be defined. When dedicated RRC signaling in a downlink collides with dedicated RRC signaling in an uplink, a collision handling rule may be not expected (e.g., such collision may be an error event). When a PDCCH in a Type-0/0A/1/1 common search space (CSS) set in a downlink collides with dedicated RRC signaling in an uplink, a collision handling rule may be not expected (e.g., such collision may be an error event). When a dynamically scheduled transmission in a downlink collides with a dynamically scheduled transmission in an uplink, a collision handling rule may be not expected (e.g., such collision may be an error event). When a dynamically scheduled transmission in a downlink collides with dedicated RRC signaling in an uplink, a collision handling rule may involve reusing an NR TDD rule. When dedicated RRC signaling in a downlink collides with a dynamically scheduled transmission in an uplink, a collision handling rule may involve reusing an NR TDD rule. When an SSB in a downlink collides with dedicated RRC signaling in an uplink, a collision handling rule may involve prioritizing the SSB. When an SSB in a downlink collides with a dynamically scheduled transmission in an uplink, a collision handling rule may involve prioritizing the SSB. When an SSB in a downlink collides with a cell-specific transmission in an uplink, a collision handling rule may be up to UE implementation. When a PDCCH in a Type-0/0A/1/1 CSS set in a downlink collides with a cell-specific transmission in an uplink, a collision handling rule may be up to UE implementation. When dedicated RRC signaling in a downlink collides with a cell-specific transmission in an uplink, a collision handling rule may be up to UE implementation. When a dynamically scheduled transmission in a downlink collides with a cell-specific transmission in an uplink, a collision handling rule may be up to UE implementation.

In some aspects, the downlink/uplink collision handling rules of Type-A HD FDD may define whether a downlink transmission or an uplink transmission should be prioritized, whether a prioritization is based at least in part on a UE implementation, and/or whether such a collision should be considered as an error case (e.g., network node should avoid such error cases). The downlink/uplink collision handling rules of Type-A HD FDD may be applicable to the virtual paired spectrum.

In some aspects, a dedicated RRC configuration for a downlink may be associated with a PDCCH in a user search space (USS), a semi-persistent scheduling (SPS) PDSCH, a CSI-RS, and/or a positioning reference signal (PRS). A dedicated RRC configuration for an uplink may be associated with a configured grant (CG) PUSCH, a PRACH, a message (e.g., MsgA) for a contention-free random access (CFRA), an SRS, and/or a PUCCH. A dynamically scheduled transmission for an uplink may be associated with a PUCCH (including hybrid automatic repeat request (HARQ) feedback for Msg4/MsgB), a PUSCH (e.g., Msg3), an SRS, and/or a PDCCH ordered PRACH. A cell-specific downlink transmission may be associated with an SSB and/or a PDCCH in a Type-0/0A/1/2 CSS. A cell-specific uplink transmission may be associated with a valid PRACH occasion (e.g., Msg1 or a MsgA preamble) and/or a valid MsgA PUSCH occasion.

In some aspects, for the collision handling between the downlink transmission and the uplink transmission of the virtual paired strum, and for the third option that involves the HD inter-band TDD-TDD carrier aggregation for the non-RedCap UE, prioritization rules may be defined. When a reference cell is associated with a semi slot format indicator (SFI) downlink (D) and another cell is associated with a semi SFI uplink (U), a UE behavior may involve dropping the semi SFI U for an inter-band (error case in an intra-band). When a reference cell is associated with semi SFI D and another cell is associated with an RRC U, a UE behavior may involve dropping the RRC U. When a reference cell is associated with a semi SFI D and another cell is associated with a dynamic U, a UE behavior may involve dropping the dynamic U for an inter-band (error case in an intra-band). When a reference cell is associated with a semi SFI U and another cell is associated with a semi SFI D, a UE behavior may involve dropping the semi SFI D for an inter-band (error case in an intra-band). When a reference cell is associated with a semi SFI U and another cell is associated with an RRC D, a UE behavior may involve dropping the RRC D. When a reference cell is associated with a semi SFI U and another cell is associated with a dynamic D, a UE behavior may be associated with an error. When a reference cell is associated with an RRC D and another cell is associated with an RRC U, a UE behavior may involve dropping the RRC U. When a reference cell is associated with an RRC U and another cell is associated with an RRC D, a UE behavior may involve dropping the RRC D. When a reference cell is associated with a dynamic D and another cell is associated with a dynamic U, a UE behavior may be associated with an error. When a reference cell is associated with a dynamic U and another cell is associated with a dynamic D, a UE behavior may be associated with an error. When a reference cell is associated with an RRC U and another cell is associated with a semi SFI D, a UE behavior may involve dropping the semi SFI D. When a reference cell is associated with an RRC D and another cell is associated with a semi SFI U, a UE behavior may involve dropping the semi SFI U. When a reference cell is associated with an RRC U and another cell is associated with a dynamic D, a UE behavior may be associated with an error. When a reference cell is associated with an RRC D and another cell is associated with a dynamic U, a UE behavior may involve dropping the RRC U for an inter-band (error case in an intra-band).

In some aspects, the prioritization rules may only address cases in which a dynamic SFI is not configured. The prioritization rules may define whether to drop a downlink or an uplink. A prioritization may be pair-wise between a pair of component carriers (CCs), where one CC is designated as a reference cell (lower cell identifier) and the other CC is designated as another cell. A reference cell designation may be based only on semi-static information. A reference cell designation time granularity may be as small as a symbol. In some aspects, a semi SFI downlink/uplink (D/U) may be designated by a common TDD uplink-downlink configuration (tdd-UL-DL-ConfigurationCommon) or a dedicated TDD uplink-downlink configuration (tdd-UL-DL-ConfigurationDedicated). An RRC D/U may be a semi-statically configured transmission/reception for a PDCCH, a PDSCH, a CSI-RS, a PUCCH, a PUSCH, and/or an SRS in flexible (X) symbols. A dynamic D/U may be a transmission/reception corresponding to a dynamic grant.

In some aspects, the prioritization rules may be per pair of cells, where a cell having a lower cell identifier may be set as a reference cell. The reference cell may generally be prioritized over another cell, and dynamic signaling may generally be prioritized over semi-static RRC signaling. The prioritization rules may be applicable to the virtual paired spectrum.

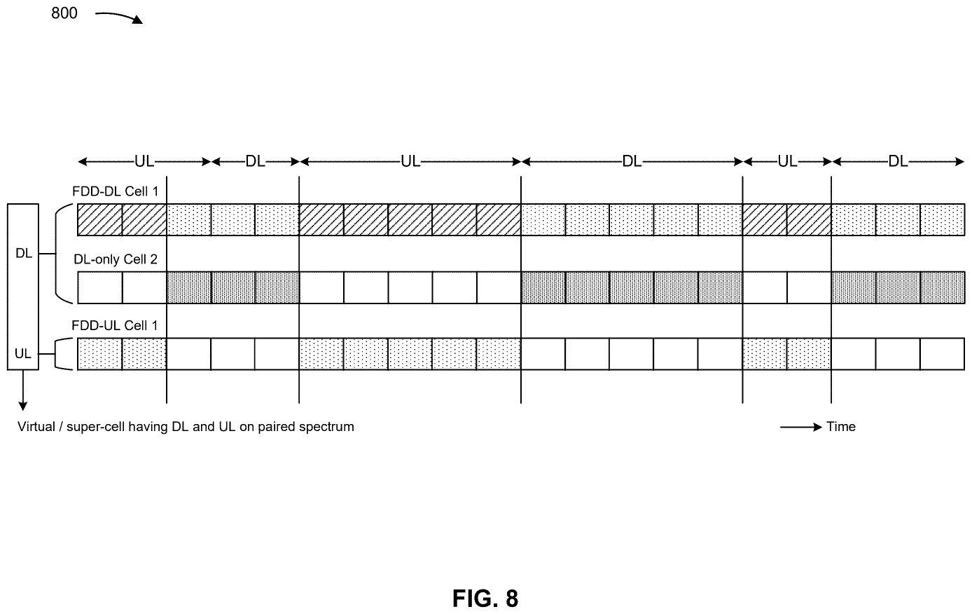

FIG. 8 is a diagram illustrating an example 800 associated with carrier aggregation switching, in accordance with the present disclosure.

As shown in FIG. 8, a UE capability may not be fully utilized. A UE may receive resources associated with FDD-DL Cell 1, but such resources may not be useable due to a half-duplex operation at the UE. In other words, the half-duplex operation may prohibit such resources from being allocated because the resources may overlap in time with resources associated with FDD-UL Cell 1. The resources associated with FDD-DL Cell 1 may correspond to a downlink and the resources associated with FDD-UL Cell 1 may correspond to an uplink.

As indicated above, FIG. 8 is provided as an example. Other examples may differ from what is described with regard to FIG. 8.

FIG. 9 is a diagram illustrating an example 900 associated with carrier aggregation switching, in accordance with the present disclosure.

In some aspects, a switching may be defined between “FDD-DL Cell 1 and FDD-UL Cell 1” and “FDD-DL Cell 1 and DL-only Cell 2”. In other words, the switching may be defined between “DL Cell 1 and UL Cell 1” and “DL Cell 1 and DL Cell 2”. The switching may be based at least in part on signaling. The signaling may include RRC signaling, a MAC-CE, or DCI. The switching may be based at least in part on a timer. The timer may be a MAC timer (per MAC entity) or a physical layer timer (per serving cell). The switching may be based at least in part on a rule. The rule may be based at least in part on a scheduled/configured transmission/reception.

As shown in FIG. 9, a UE may simultaneously receive on FDD-DL Cell 1 and transmit on FDD-UL Cell 1. At a first switch, the UE may switch from “FDD-DL Cell 1 and FDD-UL Cell 1” to “FDD-DL Cell 1 and DL-only Cell 2”, which may allow the UE to simultaneously receive on FDD-DL Cell 1 and receive on DL-only Cell 2. At a second switch, the UE may switch from “FDD-DL Cell 1 and DL-only Cell 2” to “FDD-DL Cell 1 and FDD-UL Cell 1”, which may allow the UE to simultaneously receive on FDD-DL Cell 1 and transmit on FDD-UL Cell 1. At a third switch, the UE may switch from “FDD-DL Cell 1 and FDD-UL Cell 1” to “FDD-DL Cell 1 and DL-only Cell 2”, which may allow the UE to simultaneously receive on FDD-DL Cell 1 and receive on DL-only Cell 2. At a fourth switch, the UE may switch from “FDD-DL Cell 1 and DL-only Cell 2” to “FDD-DL Cell 1 and FDD-UL Cell 1”, which may allow the UE to simultaneously receive on FDD-DL Cell 1 and transmit on FDD-UL Cell 1. At a fifth switch, the UE may switch from “FDD-DL Cell 1 and FDD-UL Cell 1” to “FDD-DL Cell 1 and DL-only Cell 2”, which may allow the UE to simultaneously receive on FDD-DL Cell 1 and receive on DL-only Cell 2. The first switch, the second switch, the third switch, the fourth switch, and/or the fifth switch may be based at least in part on signaling, a timer, and/or a rule. In this example, all resources associated with FDD-DL Cell 1 may be utilized for one or more downlink transmissions.

In some aspects, when the switching is based at least in part on the signaling, the RRC signaling may be used to configure a time domain switching pattern between “DL Cell 1 and UL Cell 1” and “DL Cell and +DL Cell 2”. The MAC-CE or the DCI may indicate a switch from “DL Cell 1 and UL Cell 1” to “DL Cell 1 and DL Cell 2,” or a switch from “DL Cell 1 and DL Cell 2” to “DL Cell 1 and UL Cell 1”. For the DCI, an indication may be an explicit indication for the UE to switch, or the UE may perform the switch based at least in part on which state the DCI schedules data on (e.g., when a UE detects an uplink grant for uplink scheduling on UL Cell 1, the UE may switch before a scheduled resource). In some aspects, when the state “DL Cell 1 and UL Cell 1” is active based at least in part on a configuration, the UE may not receive from DL Cell 2. When the state “DL Cell 1 and DL Cell 2” is active based at least in part on a configuration, the UE may not transmit on UL Cell 1. During a switch gap between “DL Cell 1 and UL Cell 1” and “DL Cell 1+DL Cell 2”, the UE may not transmit on UL Cell 1 and the UE may not receive on DL Cell 2.

In some aspects, when the switching is based at least in part on the timer, the UE may be configured with a MAC/PHY layer timer to switch back to a default state. The default state may be either “DL Cell 1 and UL Cell 1” or “DL Cell 1 and DL Cell 2”. In some cases, “DL Cell 1+UL Cell 1” may be a more reasonable default state due to an equivalence to a non-carrier-aggregation or primary cell (PCell) operation. In a non-default state, the timer may count an inactivity duration. After the timer expires, the UE may switch to the default state. When an activity occurs during the inactivity duration, the timer may be reset.

In some aspects, when the switching is based at least in part on the rule, in a first example, when the UE is configured with an uplink transmission on UL Cell 1 with a certain periodicity/timing (e.g., a periodic/semi-persistent PUCCH/PUSCH), the UE may complete a switch to “DL Cell 1 and UL Cell 1” before a periodic resource for the UL transmission starts. At least around a time of a periodic uplink transmission (including a switching gap time), the UE cannot receive a downlink transmission on DL Cell 2. In a second example, for a cell-specific/broadcast when the UE is configured with an uplink transmission on UL Cell 1 with a certain periodicity/timing (e.g., a PRACH transmission occasions/resources, or Msg-A occasions/resources), the UE may complete a switch to “DL Cell 1 and UL Cell 1” before an uplink transmission using a periodic resource starts. At least around a time of the uplink transmission on a periodic resource, the UE cannot receive a downlink transmission on DL Cell 2. In the second example, resources may be configured in a periodic manner, but the UE may or may not transmit using a periodic resource (unlike a periodic/semi-persistent PUCCH/PUSCH). The UE may perform switching when the UE transmits and may not perform switching when the UE does not transmit (e.g., the UE may perform switching only when the UE actually transmits). In a third example, for a cell-specific/broadcast downlink reception on DL Cell 2 (e.g., a SSB, a TRS, a PDCCH CSS, or a measurement RS), the UE may complete a switch to “DL Cell 1 and DL Cell 2” before a cell-specific/broadcast downlink reception on DL Cell 2 starts. At least around a time of a cell-specific/broadcast downlink reception (including a switching gap time), the UE may not be able to transmit on UL Cell 1.

As indicated above, FIG. 9 is provided as an example. Other examples may differ from what is described with regard to FIG. 9.

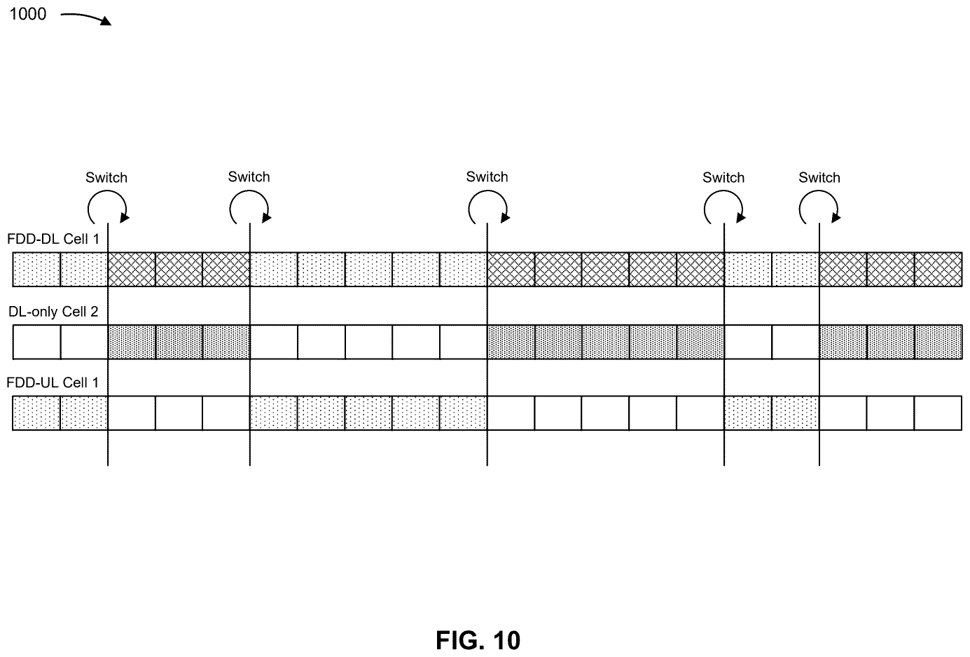

FIG. 10 is a diagram illustrating an example 1000 associated with carrier aggregation switching, in accordance with the present disclosure.

When a switching is defined between “DL Cell 1 and UL Cell 1” and “DL Cell and +DL Cell 2”, a UE may be required to support a filter bandwidth that covers both DL Cell 1 and DL Cell 2. In one example, the UE may support a filter bandwidth for either DL Cell 1 or DL Cell 2, and the UE may have to select one DL cell between DL Cell 1 and DL Cell 2 to receive a downlink transmission based at least in part on a switch.

As shown in FIG. 10, a UE may be unable to receive downlink transmissions on certain resources associated with FDD-DL Cell 1 when a UE filter is adjusted to DL-only Cell 2. In other words, the UE may be unable to receive such resources on DL Cell 1 when the UE filter is adjusted to DL Cell 2. In this example, such resources on FDD-DL Cell 2 may be wasted when the UE does not support a filter bandwidth that covers both DL Cell 1 and DL Cell 2.

As indicated above, FIG. 10 is provided as an example. Other examples may differ from what is described with regard to FIG. 10.

FIG. 11 is a diagram illustrating an example 1100 associated with carrier aggregation switching, in accordance with the present disclosure.

In some aspects, a switching may be defined between “FDD-DL Cell 1 and FDD-UL Cell 1” and DL-only Cell 2. In other words, the switching may be defined between “DL Cell 1 and UL Cell 1” and DL Cell 2. The switching may be based at least in part on signaling. The signaling may include RRC signaling, a MAC-CE, or DCI. The switching may be based at least in part on a timer. The timer may be a MAC timer (per MAC entity) or a physical layer timer (per serving cell). The switching may be based at least in part on a rule. The rule may be based at least in part on a scheduled/configured transmission/reception.

As shown in FIG. 11, a UE may simultaneously receive on FDD-DL Cell 1 and transmit on FDD-UL Cell 1. At a first switch, the UE may switch from “FDD-DL Cell 1 and FDD-UL Cell 1” to DL-only Cell 2, which may allow the UE to receive on DL-only Cell 2. At a second switch, the UE may switch from DL-only Cell 2 to “FDD-DL Cell 1 and FDD-UL Cell 1”, which may allow the UE to simultaneously receive on FDD-DL Cell 1 and transmit on FDD-UL Cell 1. At a third switch, the UE may switch from “FDD-DL Cell 1 and FDD-UL Cell 1” to DL-only Cell 2, which may allow the UE to receive on DL-only Cell 2. At a fourth switch, the UE may switch from DL-only Cell 2 to “FDD-DL Cell 1 and FDD-UL Cell 1”, which may allow the UE to simultaneously receive on FDD-DL Cell 1 and transmit on FDD-UL Cell 1. At a fifth switch, the UE may switch from “FDD-DL Cell 1 and FDD-UL Cell 1” to DL-only Cell 2, which may allow the UE to receive on DL-only Cell 2. The first switch, the second switch, the third switch, the fourth switch, and/or the fifth switch may be based at least in part on signaling, a timer, and/or a rule. In this example, certain resources associated with FDD-DL Cell 1 may not be utilized for downlink transmissions when a UE filter is adjusted to DL-only Cell 2.

In some aspects, when the switching is based at least in part on the signaling, the RRC signaling may be used to configure a time domain switching pattern between “DL Cell 1 and UL Cell 1” and DL Cell 2. The MAC-CE or the DCI may indicate a switch from “DL Cell 1 and UL Cell 1” to DL Cell 2, or a switch from DL Cell 2 to “DL Cell 1 and UL Cell 1”. For the DCI, an indication may be an explicit indication for the UE to switch, or the UE may perform the switch based at least in part on which state the DCI schedules data on (e.g., when a UE detects an uplink grant for uplink scheduling on UL Cell 1, the UE may switch before a scheduled resource). In some aspects, when the state “DL Cell 1 and UL Cell 1” is active based at least in part on a configuration, the UE may not receive from DL Cell 2. When the state DL Cell 2 is active based at least in part on a configuration, the UE may not transmit on UL Cell 1 and/or the UE may not receive on DL Cell 2. During a switch gap between “DL Cell 1 and UL Cell 1” and DL Cell 2, the UE may not transmit on UL Cell 1 and the UE may not receive on DL Cell 2.

In some aspects, when the switching is based at least in part on the timer, the UE may be configured with a MAC/PHY layer timer to switch back to a default state. The default state may be either “DL Cell 1 and UL Cell 1” or DL Cell 2. In some cases, “DL Cell 1+UL Cell 1” may be a more reasonable default state due to an equivalence to a non-carrier-aggregation or PCell operation. In a non-default state, the timer may count an inactivity duration. After the timer expires, the UE may switch to the default state. When an activity occurs during the inactivity duration, the timer may be reset.

In some aspects, when the switching is based at least in part on the rule, in a first example, when the UE is configured with an uplink transmission on UL Cell 1 with a certain periodicity/timing (e.g., a periodic/semi-persistent PUCCH/PUSCH), the UE may complete a switch to “DL Cell 1 and UL Cell 1” before a periodic resource for the UL transmission starts. At least around a time of a periodic uplink transmission (including a switching gap time), the UE cannot receive a downlink transmission on DL Cell 2. In a second example, for a cell-specific/broadcast when the UE is configured with an uplink transmission on UL Cell 1 with a certain periodicity/timing (e.g., a PRACH transmission occasions/resources, or Msg-A occasions/resources), the UE may complete a switch to “DL Cell 1 and UL Cell 1” before an uplink transmission using a periodic resource starts. At least around a time of the uplink transmission on a periodic resource, the UE cannot receive a downlink transmission on DL Cell 2. In a third example, for a cell-specific/broadcast downlink reception on DL Cell 2 (e.g., a SSB, a TRS, a PDCCH CSS, or a measurement RS), the UE may complete a switch to DL Cell 2 before a cell-specific/broadcast downlink reception on DL Cell 2 starts. At least around a time of a cell-specific/broadcast downlink reception (including a switching gap time), the UE may not be able to transmit on UL Cell 1 and the UE may not be able to receive on DL Cell 1. In a fourth example, for a cell-specific/broadcast downlink reception on DL Cell 1 (e.g., a SSB, a TRS, a PDCCH CSS, or a measurement RS), the UE may complete a switch to “DL Cell 1 and UL Cell 2” before a cell-specific/broadcast downlink reception on DL Cell 1 starts. At least around a time of a cell-specific/broadcast downlink reception (including a switching gap time), the UE may not be able to receive on DL Cell 2.

As indicated above, FIG. 11 is provided as an example. Other examples may differ from what is described with regard to FIG. 11.

FIG. 12 is a diagram illustrating an example process 1200 performed, for example, at a UE or an apparatus of a UE, in accordance with the present disclosure. Example process 1200 is an example where the apparatus or the UE (e.g., UE 120) performs operations associated with carrier aggregation switching.

As shown in FIG. 12, in some aspects, process 1200 may include receiving a configuration for a carrier aggregation that indicates an FDD-DL Cell 1, a DL-only Cell 2, and an FDD-UL Cell 1 (block 1210). For example, the UE (e.g., using reception component 1402 and/or communication manager 1406, depicted in FIG. 14) may receive

a configuration for a carrier aggregation that indicates an FDD-DL Cell 1, a DL-only Cell 2, and an FDD-UL Cell 1, as described above.

As further shown in FIG. 12, in some aspects, process 1200 may include performing a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1 (block 1220). For example, the UE (e.g., using communication manager 1406, depicted in FIG. 14) may perform a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1, as described above.

Process 1200 may include additional aspects, such as any single aspect or any combination of aspects described below and/or in connection with one or more other processes described elsewhere herein.

In a first aspect, the configuration defines a downlink carrier group that includes a first downlink carrier associated with FDD-DL Cell 1 and a second downlink carrier associated with DL-only Cell 2.

In a second aspect, alone or in combination with the first aspect, the configuration defines a paired spectrum that includes the downlink carrier group and an uplink carrier associated with FDD-UL Cell 1.

In a third aspect, alone or in combination with one or more of the first and second aspects, the FDD-DL Cell 1, the DL-only Cell 2, and the FDD-UL Cell 1 are associated with a virtual cell having a downlink and an uplink on a paired spectrum.

In a fourth aspect, alone or in combination with one or more of the first through third aspects, an FDD half-duplex operation is supported between one or more of the FDD-DL Cell 1, the DL-only Cell 2, or the FDD-UL Cell 1.

In a fifth aspect, alone or in combination with one or more of the first through fourth aspects, process 1200 includes transmitting UE capability signaling that indicates that the UE is incapable of simultaneous transmit-receive transmissions between an uplink carrier of Cell 1 and a downlink carrier of Cell 2.

In a sixth aspect, alone or in combination with one or more of the first through fifth aspects, process 1200 includes performing a collision handling between one or more of the FDD-DL Cell 1, the DL-only Cell 2, or the FDD-UL Cell 1, wherein the collision handling is between a downlink and an uplink in a virtual paired spectrum defined by the configuration.

In a seventh aspect, alone or in combination with one or more of the first through sixth aspects, the collision handling is based at least in part on one or more error cases, one or more prioritization rules for half-duplex FDD RedCap UEs, or one or more prioritization rules associated with half-duplex inter-band TDD-TDD non-RedCap UEs.

In an eighth aspect, alone or in combination with one or more of the first through seventh aspects, the switching is between a first carrier group and a second carrier group, wherein the first carrier group includes FDD-DL Cell 1 and FDD-UL Cell 1, and wherein the second carrier group includes FDD-DL Cell 1 and DL-only Cell 2.

In a ninth aspect, alone or in combination with one or more of the first through eighth aspects, the switching is based at least in part on one or more of a signaling, a timer, or a rule.

In a tenth aspect, alone or in combination with one or more of the first through ninth aspects, the signaling includes RRC signaling, a MAC-CE, or DCI, the timer includes a MAC timer or a physical layer timer, and the rule is based at least in part on a scheduled transmission, a configured transmission, a scheduled reception, or a configured reception.

In an eleventh aspect, alone or in combination with one or more of the first through tenth aspects, the switching is between a first carrier group and a second carrier group, wherein the first carrier group includes FDD-DL Cell 1 and FDD-UL Cell 1, and the second carrier group includes DL-only Cell 2.

In a twelfth aspect, alone or in combination with one or more of the first through eleventh aspects, the switching is based at least in part on one or more of a signaling, a timer, or a rule.

In a thirteenth aspect, alone or in combination with one or more of the first through twelfth aspects, the signaling includes RRC signaling, a MAC-CE, or DCI, the timer includes a MAC timer or a physical layer timer, and the rule is based at least in part on a scheduled transmission, a configured transmission, a scheduled reception, or a configured reception.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a network node or an apparatus of a network node, in accordance with the present disclosure. Example process 1300 is an example where the apparatus or the network node (e.g., network node 110) performs operations associated with carrier aggregation switching.

As shown in FIG. 13, in some aspects, process 1300 may include transmitting a configuration for a carrier aggregation that indicates an FDD-DL Cell 1, a DL-only Cell 2, and an FDD-UL Cell 1 (block 1310). For example, the network node (e.g., using transmission component 1504 and/or communication manager 1506, depicted in FIG. 15) may transmit a configuration for a carrier aggregation that indicates an FDD-DL Cell 1, a DL-only Cell 2, and an FDD-UL Cell 1, as described above.

As further shown in FIG. 13, in some aspects, process 1300 may include performing a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1 (block 1320). For example, the network node (e.g., using communication manager 1506, depicted in FIG. 15) may perform a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1, as described above.

Process 1300 may include additional aspects, such as any single aspect or any combination of aspects described below and/or in connection with one or more other processes described elsewhere herein.

In a first aspect, the configuration defines a downlink carrier group that includes a first downlink carrier associated with FDD-DL Cell 1 and a second downlink carrier associated with DL-only Cell 2.

In a second aspect, alone or in combination with the first aspect, the configuration defines a paired spectrum that includes the downlink carrier group and an uplink carrier associated with FDD-UL Cell 1.

In a third aspect, alone or in combination with one or more of the first and second aspects, the FDD-DL Cell 1, the DL-only Cell 2, and the FDD-UL Cell 1 are associated with a virtual cell having a downlink and an uplink on a paired spectrum.

In a fourth aspect, alone or in combination with one or more of the first through third aspects, an FDD half-duplex operation is supported between one or more of the FDD-DL Cell 1, the DL-only Cell 2, or the FDD-UL Cell 1.

In a fifth aspect, alone or in combination with one or more of the first through fourth aspects, process 1300 includes receiving UE capability signaling that indicates that the UE is incapable of simultaneous transmit-receive transmissions between an uplink carrier of Cell 1 and a downlink carrier of Cell 2.

In a sixth aspect, alone or in combination with one or more of the first through fifth aspects, a collision handling is performed between one or more of the FDD-DL Cell 1, the DL-only Cell 2, or the FDD-UL Cell 1, wherein the collision handling is between a downlink and an uplink in a virtual paired spectrum defined by the configuration.

In a seventh aspect, alone or in combination with one or more of the first through sixth aspects, the collision handling is based at least in part on one or more error cases, one or more prioritization rules for half-duplex FDD RedCap UEs, or one or more prioritization rules associated with half-duplex inter-band TDD-TDD non-RedCap UEs.

In an eighth aspect, alone or in combination with one or more of the first through seventh aspects, the switching is between a first carrier group and a second carrier group, wherein the first carrier group includes FDD-DL Cell 1 and FDD-UL Cell 1, and the second carrier group includes FDD-DL Cell 1 and DL-only Cell 2.

In a ninth aspect, alone or in combination with one or more of the first through eighth aspects, the switching is based at least in part on one or more of a signaling, a timer, or a rule.

In a tenth aspect, alone or in combination with one or more of the first through ninth aspects, the signaling includes RRC signaling, a MAC-CE, or DCI, the timer includes a MAC timer or a physical layer timer, and the rule is based at least in part on a scheduled transmission, a configured transmission, a scheduled reception, or a configured reception.

In an eleventh aspect, alone or in combination with one or more of the first through tenth aspects, the switching is between a first carrier group and a second carrier group, wherein the first carrier group includes FDD-DL Cell 1 and FDD-UL Cell 1, and the second carrier group includes DL-only Cell 2.

In a twelfth aspect, alone or in combination with one or more of the first through eleventh aspects, the switching is based at least in part on one or more of a signaling, a timer, or a rule.

In a thirteenth aspect, alone or in combination with one or more of the first through twelfth aspects, the signaling includes RRC signaling, a MAC-CE, or DCI, the timer includes a MAC timer or a physical layer timer, and the rule is based at least in part on a scheduled transmission, a configured transmission, a scheduled reception, or a configured reception.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 140 described in connection with FIG. 1) of the UE.

In some aspects, the apparatus 1400 may be configured to perform one or more operations described herein in connection with FIGS. 5-11. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the UE described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more

controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the UE described above in connection with FIG. 1, such as a radio, one or more RF chains, one or more transceivers, or one or more modems, each of which may in turn be coupled with one or more antennas of the UE.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1404 may be co-located with the reception component 1402.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive a configuration for a carrier aggregation that indicates an FDD-DL Cell 1, a DL-only Cell 2, and an FDD-UL Cell 1. The communication manager 1406 may perform a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1.

The transmission component 1404 may transmit UE capability signaling that indicates that the UE is incapable of simultaneous transmit-receive transmissions between an uplink carrier of Cell 1 and a downlink carrier of Cell 2. The communication manager 1406 may perform a collision handling between one or more of the FDD-DL Cell 1, the DL-only Cell 2, or the FDD-UL Cell 1, wherein the collision handling is between a downlink and an uplink in a virtual paired spectrum defined by the configuration.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 155 described in connection with FIG. 1. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system (for example, the processing system 145 described in connection with FIG. 1) of the network node.

In some aspects, the apparatus 1500 may be configured to perform one or more operations described herein in connection with FIGS. 5-11. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the network node described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the network node described above in connection with FIG. 1, such as a radio, one or more RF chains, one or more transceivers, or one or more modems, each of which may in turn be coupled with one or more antennas of the network node. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1504 may be co-located with the reception component 1502.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The transmission component 1504 may transmit a configuration for a carrier aggregation that indicates an FDD-DL Cell 1, a DL-only Cell 2, and an FDD-UL Cell 1. The communication manager 1506 may perform a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving a configuration for a carrier aggregation that indicates a frequency division duplexing (FDD) downlink (DL) (FDD-DL) Cell 1, a DL-only Cell 2, and an FDD uplink (UL) (FDD-UL) Cell 1; and performing a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1.

Aspect 2: The method of Aspect 1, wherein the configuration defines a downlink carrier group that includes a first downlink carrier associated with FDD-DL Cell 1 and a second downlink carrier associated with DL-only Cell 2.

Aspect 3: The method of Aspect 2, wherein the configuration defines a paired spectrum that includes the downlink carrier group and an uplink carrier associated with FDD-UL Cell 1.

Aspect 4: The method of any of Aspects 1-3, wherein the FDD-DL Cell 1, the DL-only Cell 2, and the FDD-UL Cell 1 are associated with a virtual cell having a downlink and an uplink on a paired spectrum.

Aspect 5: The method of any of Aspects 1-4, wherein an FDD half-duplex operation is supported between one or more of the FDD-DL Cell 1, the DL-only Cell 2, or the FDD-UL Cell 1.

Aspect 6: The method of any of Aspects 1-5, further comprising: transmitting UE capability signaling that indicates that the UE is incapable of simultaneous transmit-receive transmissions between an uplink carrier of Cell 1 and a downlink carrier of Cell 2.

Aspect 7: The method of any of Aspects 1-6, further comprising: performing a collision handling between one or more of the FDD-DL Cell 1, the DL-only Cell 2, or the FDD-UL Cell 1, wherein the collision handling is between a downlink and an uplink in a virtual paired spectrum defined by the configuration.

Aspect 8: The method of Aspect 7, wherein the collision handling is based at least in part on: one or more error cases, one or more prioritization rules for half-duplex FDD reduced capability (RedCap) UEs, or one or more prioritization rules associated with half-duplex inter-band time division duplexing (TDD)-TDD non-RedCap UEs.

Aspect 9: The method of any of Aspects 1-8, wherein the switching is between a first carrier group and a second carrier group, wherein the first carrier group includes FDD-DL Cell 1 and FDD-UL Cell 1, and wherein the second carrier group includes FDD-DL Cell 1 and DL-only Cell 2.

Aspect 10: The method of Aspect 9, wherein the switching is based at least in part on one or more of: a signaling, a timer, or a rule.

Aspect 11: The method of Aspect 10, wherein: the signaling includes radio resource control (RRC) signaling, a medium access control (MAC) control element (MAC-CE), or downlink control information (DCI); the timer includes a MAC timer or a physical layer timer; and the rule is based at least in part on a scheduled transmission, a configured transmission, a scheduled reception, or a configured reception.

Aspect 12: The method of any of Aspects 1-11, wherein the switching is between a first carrier group and a second carrier group, wherein the first carrier group includes FDD-DL Cell 1 and FDD-UL Cell 1, and wherein the second carrier group includes DL-only Cell 2.

Aspect 13: The method of Aspect 12, wherein the switching is based at least in part on one or more of: a signaling, a timer, or a rule.

Aspect 14: The method of Aspect 13, wherein: the signaling includes radio resource control (RRC) signaling, a medium access control (MAC) control element (MAC-CE), or downlink control information (DCI); the timer includes a MAC timer or a physical layer timer; and the rule is based at least in part on a scheduled transmission, a configured transmission, a scheduled reception, or a configured reception.

Aspect 15: A method of wireless communication performed by a network node, comprising: transmitting a configuration for a carrier aggregation that indicates a frequency division duplexing (FDD) downlink (DL) (FDD-DL) Cell 1, a DL-only Cell 2, and an FDD uplink (UL) (FDD-UL) Cell 1; and performing a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1.

Aspect 16: The method of Aspect 15, wherein the configuration defines a downlink carrier group that includes a first downlink carrier associated with FDD-DL Cell 1 and a second downlink carrier associated with DL-only Cell 2.

Aspect 17: The method of Aspect 16, wherein the configuration defines a paired spectrum that includes the downlink carrier group and an uplink carrier associated with FDD-UL Cell 1.

Aspect 18: The method of any of Aspects 15-17, wherein the FDD-DL Cell 1, the DL-only Cell 2, and the FDD-UL Cell 1 are associated with a virtual cell having a downlink and an uplink on a paired spectrum.

Aspect 19: The method of any of Aspects 15-18, wherein an FDD half-duplex operation is supported between one or more of the FDD-DL Cell 1, the DL-only Cell 2, or the FDD-UL Cell 1.

Aspect 20: The method of any of Aspects 15-19, further comprising: receiving user equipment (UE) capability signaling that indicates that a UE is incapable of simultaneous transmit-receive transmissions between an uplink carrier of Cell 1 and a downlink carrier of Cell 2.

Aspect 21: The method of any of Aspects 15-20, wherein a collision handling is performed between one or more of the FDD-DL Cell 1, the DL-only Cell 2, or the FDD-UL Cell 1, wherein the collision handling is between a downlink and an uplink in a virtual paired spectrum defined by the configuration.

Aspect 22: The method of Aspect 21, wherein the collision handling is based at least in part on: one or more error cases, one or more prioritization rules for half-duplex FDD reduced capability (RedCap) UEs, or one or more prioritization rules associated with half-duplex inter-band time division duplexing (TDD)-TDD non-RedCap UEs.

Aspect 23: The method of any of Aspects 15-22, wherein the switching is between a first carrier group and a second carrier group, wherein the first carrier group includes FDD-DL Cell 1 and FDD-UL Cell 1, and wherein the second carrier group includes FDD-DL Cell 1 and DL-only Cell 2.

Aspect 24: The method of Aspect 23, wherein the switching is based at least in part on one or more of: a signaling, a timer, or a rule.

Aspect 25: The method of Aspect 24, wherein: the signaling includes radio resource control (RRC) signaling, a medium access control (MAC) control element (MAC-CE), or downlink control information (DCI); the timer includes a MAC timer or a physical layer timer; and the rule is based at least in part on a scheduled transmission, a configured transmission, a scheduled reception, or a configured reception.

Aspect 26: The method of any of Aspects 15-25, wherein the switching is between a first carrier group and a second carrier group, wherein the first carrier group includes FDD-DL Cell 1 and FDD-UL Cell 1, and wherein the second carrier group includes DL-only Cell 2.

Aspect 27: The method of Aspect 26, wherein the switching is based at least in part on one or more of: a signaling, a timer, or a rule.

Aspect 28: The method of Aspect 27, wherein: the signaling includes radio resource control (RRC) signaling, a medium access control (MAC) control element (MAC-CE), or downlink control information (DCI); the timer includes a MAC timer or a physical layer timer; and the rule is based at least in part on a scheduled transmission, a configured transmission, a scheduled reception, or a configured reception.

Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-28.

Aspect 30: An apparatus for wireless communication at a device, the apparatus comprising one or more memories and one or more processors coupled to the one or more memories, the one or more processors configured to cause the device to perform the method of one or more of Aspects 1-28.

Aspect 31: An apparatus for wireless communication, the apparatus comprising at least one means for performing the method of one or more of Aspects 1-28.

Aspect 32: A non-transitory computer-readable medium storing code for wireless communication, the code comprising instructions executable by one or more processors to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

Aspect 34: A device for wireless communication, the device comprising a processing system that includes one or more processors and one or more memories coupled with the one or more processors, the processing system configured to cause the device to perform the method of one or more of Aspects 1-28.

Aspect 35: An apparatus for wireless communication at a device, the apparatus comprising one or more memories and one or more processors coupled to the one or more memories, the one or more processors individually or collectively configured to cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a +b+c, as well as any combination with multiples of the same element (for example, a +a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive a configuration for a carrier aggregation that indicates a frequency division duplexing (FDD) downlink (DL) (FDD-DL) Cell 1, a DL-only Cell 2, and an FDD uplink (UL) (FDD-UL) Cell 1; and
perform a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1.

2. The apparatus of claim 1, wherein the configuration defines a downlink carrier group that includes a first downlink carrier associated with FDD-DL Cell 1 and a second downlink carrier associated with DL-only Cell 2.

3. The apparatus of claim 2, wherein the configuration defines a paired spectrum that includes the downlink carrier group and an uplink carrier associated with FDD-UL Cell 1.

4. The apparatus of claim 1, wherein the FDD-DL Cell 1, the DL-only Cell 2, and the FDD-UL Cell 1 are associated with a virtual cell having a downlink and an uplink on a paired spectrum.

5. The apparatus of claim 1, wherein an FDD half-duplex operation is supported between one or more of the FDD-DL Cell 1, the DL-only Cell 2, or the FDD-UL Cell 1.

6. The apparatus of claim 1, wherein the one or more processors are further configured to cause the UE to:
transmit UE capability signaling that indicates that the UE is incapable of simultaneous transmit-receive transmissions between an uplink carrier of Cell 1 and a downlink carrier of Cell 2.

7. The apparatus of claim 1, wherein the one or more processors are further configured to cause the UE to:
perform a collision handling between one or more of the FDD-DL Cell 1, the DL-only Cell 2, or the FDD-UL Cell 1, wherein the collision handling is between a downlink and an uplink in a virtual paired spectrum defined by the configuration.

8. The apparatus of claim 7, wherein the collision handling is based at least in part on: one or more error cases, one or more prioritization rules for half-duplex FDD reduced capability (RedCap) UEs, or one or more prioritization rules associated with half-duplex inter-band time division duplexing (TDD)-TDD non-RedCap UEs.

9. The apparatus of claim 1, wherein the switching is between a first carrier group and a second carrier group, wherein the first carrier group includes FDD-DL Cell 1 and FDD-UL Cell 1, and wherein the second carrier group includes FDD-DL Cell 1 and DL-only Cell 2.

10. The apparatus of claim 9, wherein the switching is based at least in part on one or more of: a signaling, a timer, or a rule.

11. The apparatus of claim 10, wherein:
the signaling includes radio resource control (RRC) signaling, a medium access control (MAC) control element (MAC-CE), or downlink control information (DCI);
the timer includes a MAC timer or a physical layer timer; and
the rule is based at least in part on a scheduled transmission, a configured transmission, a scheduled reception, or a configured reception.

12. The apparatus of claim 1, wherein the switching is between a first carrier group and a second carrier group, wherein the first carrier group includes FDD-DL Cell 1 and FDD-UL Cell 1, and wherein the second carrier group includes DL-only Cell 2.

13. The apparatus of claim 12, wherein the switching is based at least in part on one or more of: a signaling, a timer, or a rule.

14. The apparatus of claim 13, wherein:
the signaling includes radio resource control (RRC) signaling, a medium access control (MAC) control element (MAC-CE), or downlink control information (DCI);
the timer includes a MAC timer or a physical layer timer; and
the rule is based at least in part on a scheduled transmission, a configured transmission, a scheduled reception, or a configured reception.

15. An apparatus for wireless communication at a network node, comprising:
one or more memories; and
one or more processors, coupled to the one or more memories, configured to cause the network node to:
transmit a configuration for a carrier aggregation that indicates a frequency division duplexing (FDD) downlink (DL) (FDD-DL) Cell 1, a DL-only Cell 2, and an FDD uplink (UL) (FDD-UL) Cell 1; and
perform a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1.

16. The apparatus of claim 15, wherein the configuration defines a downlink carrier group that includes a first downlink carrier associated with FDD-DL Cell 1 and a second downlink carrier associated with DL-only Cell 2, and wherein the configuration defines a paired spectrum that includes the downlink carrier group and an uplink carrier associated with FDD-UL Cell 1.

17. The apparatus of claim 15, wherein the FDD-DL Cell 1, the DL-only Cell 2, and the FDD-UL Cell 1 are associated with a virtual cell having a downlink and an uplink on a paired spectrum, and wherein an FDD half-duplex operation is supported between one or more of the FDD-DL Cell 1, the DL-only Cell 2, or the FDD-UL Cell 1.

18. The apparatus of claim 15, wherein the one or more processors are further configured to cause the network node to:
receive user equipment (UE) capability signaling that indicates that a UE is incapable of simultaneous transmit-receive transmissions between an uplink carrier of Cell 1 and a downlink carrier of Cell 2.

19. The apparatus of claim 15, wherein the switching is between a first carrier group and a second carrier group, and wherein:
the first carrier group includes FDD-DL Cell 1 and FDD-UL Cell 1, and the second carrier group includes FDD-DL Cell 1 and DL-only Cell 2; or the first carrier group includes FDD-DL Cell 1 and FDD-UL Cell 1, and the second carrier group includes DL-only Cell 2.

20. A method of wireless communication performed by a user equipment (UE), comprising:
receiving a configuration for a carrier aggregation that indicates a frequency division duplexing (FDD) downlink (DL) (FDD-DL) Cell 1, a DL-only Cell 2, and an FDD uplink (UL) (FDD-UL) Cell 1; and
performing a communication via one or more of the FDD-DL Cell 1, the DL-only Cell 2, or the FDD-UL Cell 1 based at least in part on a switching between one or more of the FDD-DL Cell 1, the DL-only Cell 2, or the FDD-UL Cell 1.
